(19) United States
(12) Patent Application Publication
(10) Pub. No.: US 2010/0005053 A1
(43) Pub. Date: Jan. 7, 2010

(54) METHOD FOR ENABLING DISCRETE BACK/FORWARD ACTIONS WITHIN A DYNAMIC WEB APPLICATION

(76) Inventor: Philip F. Estes, Palmyra, VA (US)

Correspondence Address: LAW OFFICE OF IDO TUCHMAN (AUS), ECM #72212, PO Box 4668, New York, NY, 10163-4668, US

(21) Appl. No.: 12/168,092

(22) Filed: Jul. 4, 2008

(51) Int. Cl. G06F 17/30

(52) U.S. Cl. 707/1; 707/103 R; 707/E17.055; 707/E17.001

(57) ABSTRACT

A method, system and computer program product for managing a browsing history for a web browser. The web browser is configured to display web page content. A web page is addressable by a Uniform Resource Locator. New page content from a server is received at the web browser. A subset of a current web page is replaced with the new page content. The subset thus replaced does not include a complete web page. A data entry is stored in a chronologically ordered history list. The data entry comprises a hierarchical, object-oriented model representation of the new page content. The model representation may be a subset of a Document Object Model. At least one history navigation button is provided for traversing the history list. Page content stored at the history list is redisplayed. Backward and forward navigation within applications embodying Web 2.0 technologies, including AJAX, is thus facilitated.

### FIELD OF THE INVENTION

The present invention relates generally to the World Wide Web. More specifically, the present invention relates to improved techniques for managing a browsing history for a web browser in the context of the Web 2.0 paradigm.

### BACKGROUND

The Internet is a worldwide computing network offering a wide variety of services to its participants. One notable Internet-based service is the World Wide Web, commonly known as the “WWW” or “web”. The World Wide Web is a communication means by which both static information and dynamic, interactive applications can be delivered. The World Wide Web is decentralized in nature; it consists of literally millions of servers which are typically independent of each other. A specific World Wide Web server, or “web server”, hosts specific applications and data. A technological device known in the art as a web browser enables a user to access the applications and data hosted at a specified web server.

Historically, information accessible via the WWW has been divided into discrete units known as web pages. A web page is typically accessible using addressing information known as a Uniform Resource Locator (URL). For example, by typing the URL “http://www.ibm.com/” into a web browser, a user may access the home page of International Business Machines Corporation. Those skilled in the art will appreciate that a home page is a main page or an entry page for a website. Normally, a window or frame in a web browser displays a single web page, although many exceptions to this broad guideline exist.

A web page may contain one or more hyperlinks, often simply called “links”. Historically, a hyperlink usually contained a URL of a page to be loaded when the hyperlink was followed. Following such a hyperlink generally caused the current page to be completely replaced by the page specified by the hyperlink.

Originally, the WWW was designed to transmit and receive static web pages. Specifically, web pages were stored at a web server and were transmitted in response to a request including a URL matching the address of the web page. The WWW subsequently evolved to incorporate functionality for generating dynamic web pages. Examples of such functionality include the Common Gateway Interface (CGI) specification, the PHP platform and the Java™ Server Pages (JSP™) platform. Java and JSP are trademarks of Sun Microsystems, Inc., Santa Clara, Calif., United States, in the United States and other countries. Web-based applications can be designed based on this dynamic functionality. However, early web-based applications were limited by the paradigm described above wherein a web page generally constitutes a discrete unit. Thus, a web browser executing an early web-based application generally submitted a request to a web server and waited for the web server to return an entire web page in response. As a result, early web-based applications typically have a lower degree of interactivity than traditional desktop-based applications.

A newer paradigm, commonly known as “Web 2.0”, addresses the limitations of the paradigm described above. The Web 2.0 paradigm enables web-based applications to be highly interactive. Specifically, under the Web 2.0 paradigm, an action may cause the current web page to be modified instead of completely replaced. An application executing at a web browser may submit a request containing a relatively small amount of information to a web server. The response by the web server may result in only a subset of the current web page being changed. For example, a user may select an option from a first drop-down menu. A request specifying the selected option may be transmitted to a web server. The web server may receive the request and transmit a response including a list of choices corresponding to the selected option. The only resulting change to the current page may be the addition of the list of choices to a second drop-down menu listed on the same page.

A notable feature of the Web 2.0 paradigm is that a significant number of user actions may be performed within the same web page. It is common in Web 2.0 applications for several distinct pages or steps to occur within the same web page. Web 2.0 applications may even display completely new information in the current web page, thus simulating a transition to a new web page, without in fact loading a complete web page or URL. Therefore, while the concept of a web page still exists under the Web 2.0 paradigm, the web page can no longer be considered a discrete unit of information.

### SUMMARY OF THE INVENTION

The present invention introduces improved techniques for managing a browsing history for a web browser. The improved techniques enable backward and forward navigation to work with web-based applications embodying the Web 2.0 paradigm in a manner which is semantically and conceptually consistent with the traditional web browser user interface. This is achieved by enabling web-based applications to provide information about user interface transitions within the Web 2.0 paradigm to a web browser. Furthermore, by integrating the techniques with the web browser, consistency across a wide range of web-based applications is ensured.

Thus, one aspect of the present invention is a method for managing a browsing history for a web browser. The web browser is configured to display web page content. A web page is addressable by a Uniform Resource Locator (URL). The method comprises receiving, at the web browser, new page content from a server. The method further comprises replacing a subset of a current web page with the received new page content. The replaced subset does not include a complete web page. The method further comprises storing a data entry in a chronologically ordered history list. The data entry comprises a model representation of the new page content. The model representation is hierarchical and object-oriented. The method further comprises providing at least one history navigation button for traversing the history list. The method further comprises redisplaying page content stored at the history list.

Another aspect of the present invention is a system for managing a browsing history for a web browser. The web browser is configured to display web page content. A web page is addressable by a Uniform Resource Locator (URL). The system comprises a processor. The system further comprises a receiving unit configured to receive, at the web browser, new page content from a server. The system further comprises a replacing unit configured to replace a subset of a current web page with the received new page content. The replaced subset does not include a complete web page. The system further comprises a storing unit configured to store a data entry in a chronologically ordered history list. The data entry comprises a model representation of the new page content. The model representation is hierarchical and object-oriented. The system further comprises a navigation unit configured to provide at least one history navigation button for traversing the history list. The system further comprises a redisplaying unit configured to redisplay page content stored at the history list.

Another aspect of the present invention is a computer program product embodied in computer readable memory comprising computer readable program codes coupled to the computer readable memory for managing a browsing history for a web browser. The computer readable program codes are configured to cause the program to receive, at the web browser, new page content from a server. The computer readable program codes are further configured to cause the program to replace a subset of a current web page with the received new page content. The replaced subset does not include a complete web page. The computer readable program codes are further configured to cause the program to store a data entry in a chronologically ordered history list. The data entry comprises a model representation of the new page content. The model representation is hierarchical and object-oriented. The computer readable program codes are further configured to cause the program to provide at least one history navigation button for traversing the history list. The computer readable program codes are further configured to cause the program to redisplay page content stored at the history list.

The foregoing and other features, utilities and advantages of the invention will be apparent from the following more particular description of various embodiments of the invention as illustrated in the accompanying drawings.

### BRIEF DESCRIPTION OF THE DRAWINGS

FIG. 1 shows one environment in which an embodiment of the present invention can be implemented.

FIG. 2 demonstrates an embodiment of a system for managing a browsing history for a web browser as contemplated by the present invention.

FIG. 3 illustrates a history list as contemplated by the present invention.

FIG. 4 shows an API providing an interface to the present invention.

FIG. 5 demonstrates a flowchart of operations for managing a browsing history for a web browser.

### DETAILED DESCRIPTION OF THE INVENTION

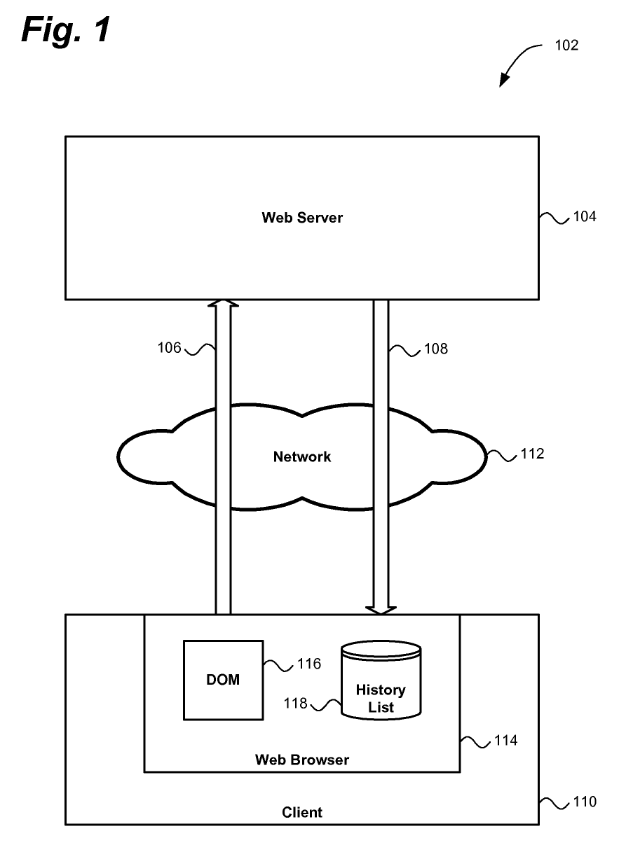

The following description details how the present invention is employed to manage a browsing history for a web browser. Throughout the description of the invention reference is made to FIGS. 1-5. When referring to the figures, like structures and elements shown throughout are indicated with like reference numerals.

FIG. 1 shows an environment 102 in which an embodiment of the present invention can be implemented.

The environment 102 includes one or more web servers 104. A web server may be a general purpose computer. A web server may be based on a general purpose operating system such as IBM® z/OS®, IBM® AIX®, Linux® or Windows®. IBM, z/OS and AIX are registered trademarks of International Business Machines Corporation, Armonk, N.Y., United States, in the United States, other countries, or both. Linux® is the registered trademark of Linus Torvalds in the United States and other countries. Windows is a registered trademark of Microsoft Corporation, Redmond, Wash., United States, in the United States and/or other countries. A web server implements one or more computer program products configured to transmit static information via the World Wide Web. The one or more computer program products may be further configured to execute dynamic web-based applications and transmit the results of the applications via the WWW. Such computer program products may include WebSphere® Application Server, the Apache™ web server and PHP. WebSphere is a registered trademark of International Business Machines Corporation, Armonk, N.Y., United States, in the United States, other countries, or both. Apache is a trademark of The Apache Software Foundation, Forest Hill, Md., United States. A web server may also comprise a database and/or logic for accessing a database hosted at another server. Such databases may include the DB2® database and the MySQL® database. DB2 is a registered trademark of International Business Machines Corporation, Armonk, N.Y., United States, in the United States, other countries, or both. MySQL is a registered trademark of MySQL AB, Uppsala, Sweden, in the United States, the European Union and other countries. A web server may be connected to a variety of peripheral devices, including without limitation a display, a keyboard, a mouse, and one or more disk drives.

The web server 104 may host any of a wide variety of websites and web-based applications. A web-based application hosted at the web server may be based on the Web 2.0 paradigm. The web-based application may be based on the Asynchronous JavaScript™ And XML (AJAX) application model. JavaScript is a trademark of Sun Microsystems, Inc., Santa Clara, Calif., United States, in the United States and other countries. The web-based application may be, for example, an order processing system. As another example, the web-based application may be an application allowing an end user to upload a photograph.

A web server 104 may be configured to receive requests 106. Requests may be transmitted according to a wide variety of protocols known in the art. In particular, requests may be transmitted according to the Hypertext Transfer Protocol (HTTP), a protocol known in the art for retrieving data via Internet-based networks. Requests may also be transmitted according to the Hypertext Transfer Protocol over Secure Socket Layer (HTTPS), which is functionally similar to HTTP while offering greater security. Requests may also be transmitted according to the File Transfer Protocol (FTP), a protocol known in the art for transmitting files. A request may indicate a Uniform Resource Locator (URL) of a web page or other data whose contents are to be retrieved. A request may additionally specify other data relevant to the request, including without limitation POST variables.

It is noted that a URL is a specific type of Uniform Resource Identifier (URI). Accordingly, the present invention can be implemented based on URI's instead of URL's.

In response to a request, a web server 104 may transmit a response 108. The response may be transmitted via HTTP, HTTPS, FTP or other protocol known in the relevant art. It is contemplated that the response is transmitted according to the same protocol employed to transmit the request 106. The response may contain static data. The response may instead contain data which was dynamically generated by the web server upon receipt of the request. The response may include an entire web page. A response may instead include a subset of a web page or data relevant to a web page. The response may be expressed in any of a variety of data formats, including without limitation HyperText Markup Language (HTML), Extensible Markup Language (XML) and JavaScript Object Notation (JSON).

The environment 102 further includes one or more clients 110. A client may be implemented in hardware, in software or a combination thereof. A client may be a general purpose computer. Such a computer may be based on a general purpose operating system such as the Linux operating system, the Windows operating system or the Mac OS® operating system. Mac OS is a registered trademark of Apple Inc., Cupertino, Calif., United States. A client may be connected to a variety of peripheral devices, including without limitation a display, a keyboard, a mouse, and one or more disk drives. Web page content may be displayed to an end user via the display.

The environment 102 further includes a computer network 112. Requests 106 from a client 110 to a web server 104 and responses 108 thereto may be transmitted via the computer network. The computer network may be any of a wide variety of systems known in the art for allowing two or more systems to communicate. The computer network may comprise any of a wide variety of networks such as the Internet, the public switched telephone network (PSTN), local area networks (LAN's) and wide area networks (WAN's). The computer network may employ any of a wide variety of network technologies such as Ethernet, IEEE 802.11, IEEE 802.16, the Bluetooth® technology, token ring, Digital Subscriber Line (DSL), cable Internet access, satellite Internet access, Integrated Services Digital Network (ISDN) and dial-up Internet access. Bluetooth is a registered trademark of Bluetooth SIG, Inc., Bellevue, Wash., United States. The computer network may include various topologies and protocols known to those skilled in the art, such as TCP/IP, UDP, and Voice over Internet Protocol (VoIP). The computer network may comprise direct physical connections, radio waves, microwaves or any combination thereof. Furthermore, the computer network may include various networking devices known to those skilled in the art, such as routers, switches, bridges, repeaters, etc.

Each client 110 includes at least one web browser 114. As used herein, the term web browser includes any of a variety of technological devices for retrieving information via a computer network and displaying the information to a user. A web browser may be implemented in software, hardware or a combination thereof. Web browsers typically are configured to retrieve information using HTTP. However, a web browser may also retrieve information according to protocols such as HTTPS and FTP.

A web browser 114 may be a computer program product such as the Firefox® web browser, the Internet Explorer® web browser or the Safari™ web browser. Firefox is a registered trademark of the Mozilla Foundation, Mountain View, Calif., United States. Internet Explorer is a registered trademark of Microsoft Corporation, Redmond, Wash., United States, in the United States and/or other countries. Safari is a trademark of Apple Inc., Cupertino, Calif., United States. Computer program products such as the foregoing may be modified to implement the present invention. The web browser may also be a computer program product designed specifically to implement the present invention.

A web browser 114 may provide one or more programming languages for executing program code at the client 110. Notably, the web browser may provide the JavaScript programming language and its runtime Application Programming Interfaces (API's). Those skilled in the art will appreciate that the JavaScript programming language facilitates dynamic manipulation of web page content and dynamic interaction with the end user of the web page content. The web browser may thus execute program code expressed in the JavaScript programming language and included in a web-based application.

It is noted that the syntax of the JavaScript programming language and the functionality of the API's provided by the JavaScript environment vary somewhat from web browser to web browser. In practice, these differences are mitigated by the fact that the core functionality provided by the JavaScript environment is generally available in all major web browsers. Furthermore, web-based applications may import common libraries which serve as an abstraction layer and hide from the application the differences between features such as, for example, Document Object Model accessors.

A web browser 114 may maintain a Document Object Model 116. As used herein, the term Document Object Model (DOM) is a representation of a state of a document displayed in a web browser. The document represented by a DOM 116 may be a web page or may otherwise comprise web page content. A DOM generally includes an internal representation of each element within a document which influences the display of the document. In the case of binary data such as the contents of an image, the internal representation may be addressing information identifying a location external to the DOM at which the binary data can be located. The addressing information may be a URL associated with the binary data. Thus, the DOM may omit the binary data itself.

A DOM may also include metadata which does not influence the display of the document. For example, the DOM may include a Uniform Resource Locator (URL) associated with the current page. As used herein, the term Display Subset includes the subset of a Document Object Model which influences the display of a document represented by the Document Object Model.

A web browser 114 may implement the DOM 116 as a tree data structure. The tree data structure is based at a root node. Other nodes are directly or indirectly connected to the root node via parent-child relationships which follow the rules of the DOM. A DOM having the tree data structure as described above may be represented internally to the browser as a well-formed XML document.

The web browser 114 may provide an API for accessing and manipulating the DOM 116. The API may be based on the JavaScript programming language. Therefore, program code included in a web-based application and executed at a client 110 can modify the currently displayed web page by manipulating structures within the DOM. For example, page elements such as colors, content and images can be moved, caused to appear, caused to disappear and otherwise altered by such program code. This ability to access and modify the DOM enables the Web 2.0 paradigm because part of a page can be modified using this ability without requiring reloading of the entire page.

In an embodiment of the present invention, the web browser 114 implements the Asynchronous JavaScript And XML (AJAX) application model. Thus, the web browser may execute web-based applications implementing the AJAX application model. In the AJAX application model, a web-based application includes asynchronous, hidden interaction between the web server 104 and the client 110. The hidden interaction may comprise transmitting requests to the web server by program code expressed in the JavaScript programming language and executed at the web browser. The program code may subsequently receive and process responses to the requests. This interaction is asynchronous because it may occur simultaneously with other, visible activity by the web-based application and/or the end user. Changes to the user interface under the AJAX application model are displayed by manipulating the DOM within the JavaScript environment in the manner described above. Specifically, the internal representation of the DOM as an XML document may be manipulated by program code expressed in the JavaScript programming language. When using an AJAX application, an end user may have the impression of moving between pages or views despite the web browser not reloading the entire web page.

A web browser 114 may request an entire web page from a web server 104. In this case, the web browser transmits a request 106 to the web server. The request may indicate the URL of the requested web page. In response to the request, the web server generally transmits a response 108 including the contents of the requested web page. The web browser receives the response. The web browser may update the DOM 116 to include substantially all of the contents of the requested web page. The web browser then displays the contents of the requested web page included in the response. It is noted that displaying the web page may be achieved by rendering the DOM instead of the contents included in the response itself. Specifically, updates to the DOM, regardless of their source, may be reflected in the currently displayed web page.

Displaying may comprise displaying information in a visual form. Displaying may also include representing information in an audio form. For example, a web page may include audio content which clearly must be rendered in an audio form. Additionally, a web page designed for visual display may instead be rendered in an audio form for the benefit of a user with a visual impairment.

A web browser 114 may also request a subset of a web page from a web server 104. Such a subset may modify the current web page without completely replacing the page. In this case, as in the previous case, the web browser transmits a request 106 to the web server. The request may indicate the URL of the requested subset. In response to the request, the web server generally transmits a response 108 including the requested subset. The web browser receives the response. The web browser may update the DOM 116, which may contain a representation of a current web page, to include the received subset of a web page. As previously noted, such updates to the DOM may cause the currently displayed web page to be updated. Accordingly, the current displayed web page includes the received subset of a web page.

A web browser 114 may also request data relevant to a web page from a web server 104. Again, such data may modify the current web page without completely replacing the page. In this case, as in the previous case, the web browser transmits a request 106 to the web server. The request may indicate the URL of the requested data. In response to the request, the web server generally transmits a response 108 including the requested data. The web browser receives the response. The web browser may then process the data included in the response. The web browser may update the DOM 116, which may contain a representation of a current web page, based on this processing. Again, such updates to the DOM may cause the currently displayed web page to be updated. Accordingly, the current displayed web page is updated based on the received data.

It is advantageous for a user to be able to return to previous states and previously accessed pages. Therefore, a web browser 114 maintains a history list 118 at which previous states are saved. The web browser additionally provides user interface elements for accessing states saved at the history list.

To access previous states, a web browser 114 may provide a Back button. As used herein, the term Back button means a user interface element causing an earlier state to be redisplayed in a web browser. A Back button may be, but is not required to be, a physical button or a button in a graphical user interface (GUI). A Back button may cause an earlier state stored at the history list 118 to be redisplayed.

After redisplaying a previous state using the Back button, a user may wish to return to a subsequent state. For example, a user may be unclear on the best answer to input to an HTML form. However, a previously viewed web page may contain the best answer. To view the answer, the user may wish to backtrack to this web page. Accordingly, the user may press the Back button until the state including the web page containing the answer is redisplayed. After noting the information, the user may then wish to redisplay the form in order to complete it. To access subsequent states, a web browser 114 may include a Forward button. As used herein, the term Forward button means a user interface element causing a state which is later than the currently displayed state to be redisplayed in a web browser. A Forward button may be, but is not required to be, a physical button or a button in a graphical user interface (GUI). A Forward button may cause a later state stored at the history list 118 to be redisplayed. Thus, in this example, the user may press the Forward button until the form is redisplayed.

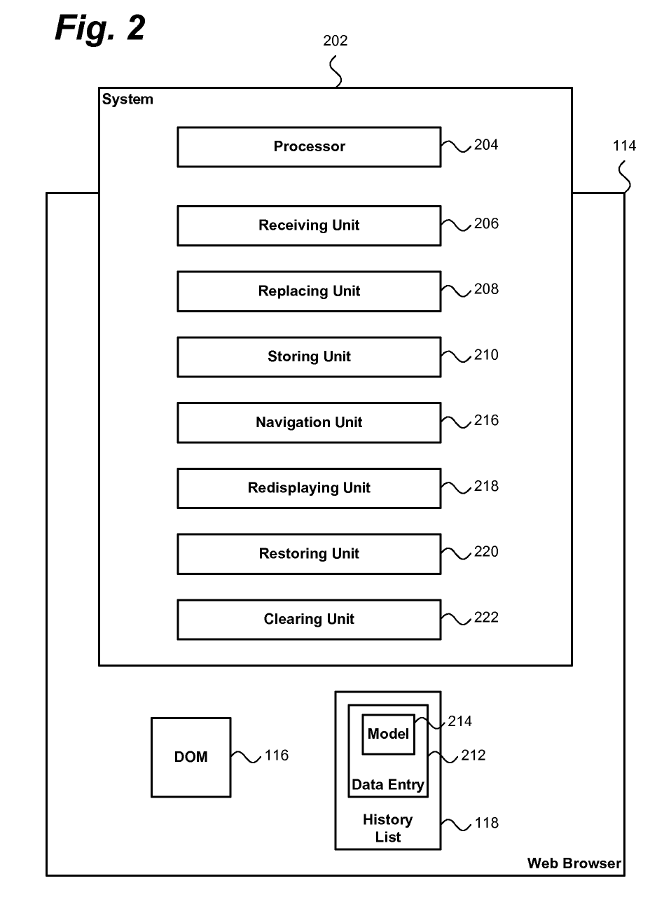

FIG. 2 illustrates one system for managing a browsing history for a web browser contemplated by the present invention. The system 202 is configured to manage a browsing history for a web browser 114. In the embodiment of FIG. 2, the system is incorporated into the web browser. Nonetheless, the system may comprise components which are distinct from the web browser. It is contemplated that the present invention impacts structures internal to the web browser, notably the browsing history. In another embodiment of the present invention, the system is distinct from the web browser.

In an embodiment of the present invention, the web browser 114 implements the system 202 and the present invention using Application Programming Interfaces (API's).

The web browser 114 is configured to display web page content. A web page is addressable by a Uniform Resource Locator (URL). The web browser may be the web browser shown in FIG. 1 and may have any of the properties described above in regards to FIG. 1.

The web browser 114 may maintain a Document Object Model (DOM) 116. The DOM may be a representation of the state of the document or web page currently displayed in the web browser. The DOM may be the DOM shown in FIG. 1 and may have any of the properties described above in regards to FIG. 1.

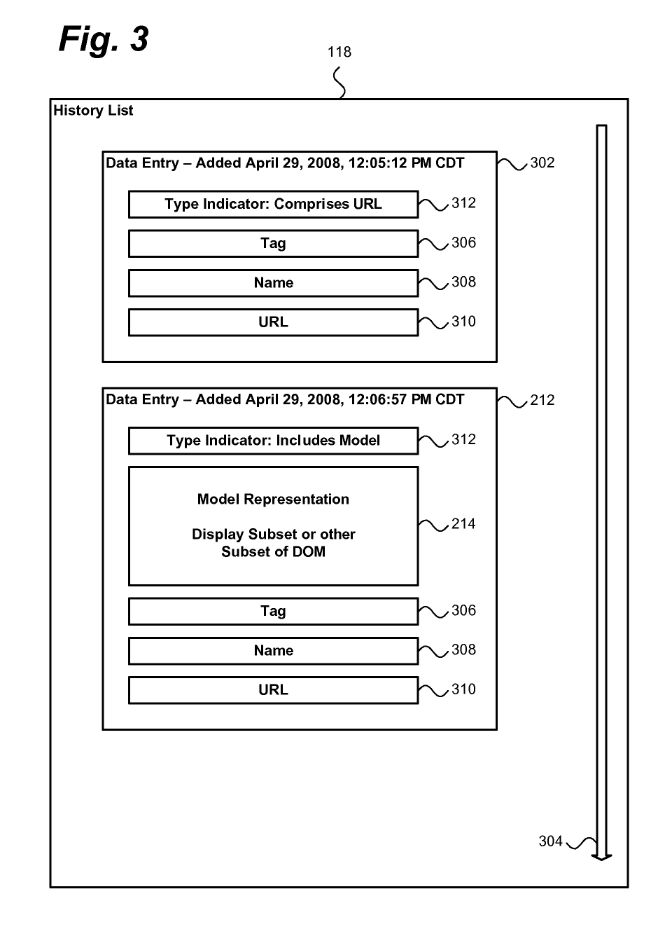

A history list 118 may be shared between the system 202 and the web browser 114. The history list 118 may be stored at the system, the web browser or a combination thereof. It is contemplated that the history list is chronologically ordered. The history list may be the history list shown in FIG. 3 and may have any or all of the properties described below in regards to FIG. 3.

The system comprises a processor 204. A processor may be a general purpose microprocessor. The processor is configured to execute program code.

The system further comprises a receiving unit 206. The receiving unit is configured to receive, at the web browser 114, new page content from a server. The server may be a web server such as the web server shown in FIG. 1. The new page content may have been received as a response to a request as shown in FIG. 1.

The system further comprises a replacing unit 208. The replacing unit is configured to replace a subset of a current web page with the new page content received by the receiving unit 206. The replaced subset does not include a complete web page.

In an embodiment of the present invention, the replacing unit 208 updates a DOM 116 corresponding to the current web page to reflect the received new page content. Specifically, a subset of the DOM is replaced with the new page content. Thus, the DOM for the current web page includes the new page content. As a result, the currently displayed web page includes the new page content.

The system further comprises a storing unit 210. The storing unit is configured to store a data entry 212 in a chronologically ordered history list 118. The data entry may comprise a model representation 214 of the new page content. The model representation is hierarchical and object-oriented.

The data entry 212 may be any of the data entries shown in FIG. 3 and may have any of the properties described below in regards to FIG. 3. Likewise, the model representation 214 may be the model representation shown in FIG. 3 and may have any of the properties described below in regards to FIG. 3.

The model representation 214 is not required to be strictly limited to the new page content. Specifically, the model representation may include elements within a web page which were not included in received new page content.

In an embodiment of the present invention, the model representation 214 is substantially equivalent to a subset of a Document Object Model (DOM). The storing unit 210 thus saves the DOM 116 for the current web page, or a subset thereof, as the model representation. In this embodiment, the replacing unit 208 updates the DOM 116 to reflect the received new page content as noted above. Therefore, the model representation includes a representation of the new page content.

It is emphasized that a checkpoint of the current state of the DOM 116, and by extension the current web page, is thus saved at the history list 118. Furthermore, saving the current state as described above may occur at any point in the application flow. By repeating this process at specific points in time, checkpoints can be saved at various intervals. Because the history list can be accessed via user interface elements such as the Back button and the Forward button, the checkpoints can be accessed at a later point in time via these user interface elements.

The system further comprises a navigation unit 216. The navigation unit is configured to provide at least one history navigation button for traversing the history list 118. A history navigation button may be a Back button or a Forward button as defined above.

The system further comprises a redisplaying unit 218. The redisplaying unit is configured to redisplay page content stored at the history list 118. The redisplaying unit 218 may be further configured to update a Document Object Model (DOM) 116 to include substantially all of the information in the model representation 214 in the stored data entry 212.

Pressing or otherwise activating a history navigation button provided by the navigation unit 216 may cause the redisplaying unit 218 to perform any of the actions described above. Specifically, pressing or otherwise activating a Back button may cause the redisplaying unit to determine whether an earlier data entry 212 in the history list 118 exists. If an earlier data entry exists, the redisplaying unit accesses the data entry. If the accessed data entry includes a model representation 214, the redisplaying unit then redisplays page content included in the model representation included in the accessed data entry. It is emphasized that as a result, the end user may perceive a reversion to the preceding point within the application flow.

If the current web page is stored at the history list, the most recently stored data entry corresponds to the current state. Therefore, the second most recently stored data entry in fact corresponds to the preceding saved state. In this case, the redisplaying unit may access the second most recently stored data entry. It is noted that in this case, if only one data entry is stored at the history list, that data entry is not in fact a previous state. Therefore, the redisplaying unit may treat this case as if no earlier data entry exists.

If instead the current web page is not stored at the history list, the redisplaying unit may access the most recently stored data entry.

Moreover, pressing or otherwise activating a Forward button may cause the redisplaying unit 218 to determine whether a later data entry 212 in the history list 118 exists. If a later data entry exists, the redisplaying unit accesses the data entry. If the accessed data entry includes a model representation 214, the redisplaying unit then redisplays page content included in the model representation included in the accessed data entry.

It is emphasized that as a result, the Back button and the Forward button may access knowledge of the points considered by the web-based application to represent state changes. Thus, the Back button and the Forward button are operable to revert to the points representing state changes.

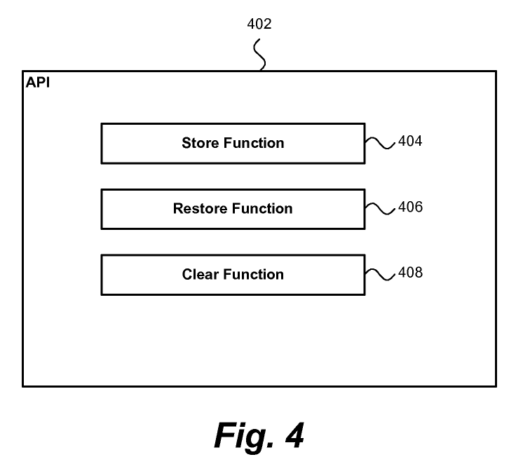

The system may further comprise a restoring unit 220. The restoring unit is configured to provide a restore function. The restore function is configured to redisplay page content stored at the history list 118. The restore function may be the restore function shown in FIG. 4.

The system may further comprise a clearing unit 222. The clearing unit is configured to provide a clear function. The clear function is configured to remove one or more stored data entries 212 from the history list 118. The clear function may be the clear function shown in FIG. 4.

Turning now to FIG. 3, a sample history list contemplated by the present invention is illustrated.

In an embodiment of the present invention, the history list of a web browser is modified to include any or all of the structures shown in FIG. 3. Thus, the history list 118 is stored at a web browser but is fully accessible to a system implementing the present invention. Furthermore, user interface elements for navigation implemented by the web browser, including the Back button and Forward button, are modified to utilize the model representation 214 and any other structures shown in FIG. 3.

The history list 118 comprises zero or more data entries 212, 302. The number of data entries stored at the history list is not fixed. To the contrary, data entries may be added or removed from the history list. Furthermore, the history list includes two data entries solely because this number suffices to demonstrate the present invention. It is emphasized that the number of data entries stored at the history list is not limited to two. To the contrary, dozens or even hundreds of data entries may be stored at a history list.

It is contemplated that the history list 118 is chronologically ordered 304. Such chronological ordering may be based on the time at which each data entry 212, 302 was initially added to the history list.

In an embodiment of the present invention, the history list 118 is implemented as a stack or a data structure similar to a stack. It is contemplated that redisplaying the page content in the most recent data entry in the history list will occur frequently. A stack facilitates this frequent case because the most recently saved data entry can be accessed simply by accessing the top of the stack, e.g., by performing a pop operation. However, those skilled in the art will appreciate that if the current page is not the most recent entry in the history list, many web browsers permit traversing the history list in a forward direction in order to return to more recent entries in the history list. To enable this functionality, the history list may preserve data entries which are popped off the stack (in contrast to typical stacks known in the art, in which popped elements are simply discarded.) Data entries popped off the stack may be preserved until and unless an end user or an application expressly clears the history list. A pointer may point to the current data entry in the history list. The pointer may move backward and forward within the history list.

In a further embodiment of the present invention, the stack includes a sub-data structure for storing metadata. Such metadata may include the name 308 of the page. The sub-data structure beneficially allows the metadata to be preserved.

In an embodiment of the present invention, a sublist is inserted into an existing data structure provided by a web browser for storing history information. A sublist is inserted at points where an end user visits a website or web-based application configured to interoperate according to the present invention. A sublist may be a stack or a stack-like data structure as described above. A Back button and/or a Forward button provided by the web browser traverses the sublists in addition to the existing data structure for storing history information. The history list is therefore a continuous list which may contain both data entries including model representations as in the present invention and data entries based on URL's as in the prior art.

A data entry 212 may comprise a model representation 214 of new page content. The model representation is hierarchical. Furthermore, the model representation is object-oriented. It is emphasized that the model representation is not required to be strictly limited to the new page content. Specifically, the model representation may include elements within a web page which were not included in received new page content.

As previously noted, the model representation 214 may be substantially equivalent to a subset of a Document Object Model (DOM). In an embodiment of the present invention, the model representation 214 is substantially equivalent to a Display Subset of the DOM.

The model representation may be expressed in any of a wide variety of specific data formats. In an embodiment of the present invention, the model representation is expressed in Extensible Markup Language (XML).

Each data entry in the history list may comprise a tag. Accordingly, a data entry 212, 302 may further comprise a tag 306. A data entry may be accessed by specifying the tag. In an embodiment of the present invention, a data entry may comprise a plurality of tags. This may beneficially facilitate classification of data entries, as all data entries belonging to the same category may share a common tag value while still being individually accessible.

A data entry 212, 302 may further comprise a name 308. The name may be a human-readable identifier of the page content included in the data entry. Visual displays of the history list 118 may include the name. Moreover, it is customary in web browsers known in the art to identify a page with a nonexistent or unknown name by its URL when displaying a history list. However, this convention is problematic in the context of the present invention because multiple entries in the history list may be associated with the same URL. For example, if ten stored data entries correspond to the same URL, the history list would display the same URL repeated ten times without distinguishing the saved states from each other in any way. Therefore, storing the name advantageously assists users in selecting page content in the history list to be redisplayed. In the preceding example, each of the ten stored data entries could include a different and appropriate name, thus distinguishing the saved states from each other.

In an embodiment of the present invention, the tag 306 and the name 308 are the same data field. Thus, the same identifier is employed to access the data entry and to visually display the name associated with the data entry.

A data entry 212, 302 may further comprise a URL 310. Those skilled in the art will appreciate that web browsers customarily display the URL associated with the current page in a Location bar. Thus, storing the URL advantageously facilitates displaying the URL associated with page content in the Location bar when the page content is redisplayed. It is contemplated that even if the URL is included in a subset of a DOM which is stored at the data entry, the URL is nonetheless stored separately from the subset of the DOM. The DOM may be a complex data structure, and significant amounts of processor time may be required to analyze the DOM in order to extract specific information. Therefore, storing the URL separately advantageously allows more efficient access to the URL.

Each data entry in the history list may comprise a type indicator. Accordingly, a data entry 212, 302 may further comprise a type indicator 312. The type indicator may specify the general type of information included in the data entry. In an embodiment of the present invention, the type indicator is an element selected from an enumerated list of possible values. The possible values may be “URL” and “DOM”.

The type indicator 312 may indicate that the stored data entry includes a model representation. The data entry 212 includes a type indicator which indicates that the stored data entry includes a model representation.

The type indicator 312 may also indicate that the data entry comprises a URL. The data entry 302 includes a type indicator which indicates that the stored data entry comprises a URL. A data entry having a type indicator which indicates that the data entry comprises a URL may omit the model representation 214.

Logic may be implemented to differentiate between data entries based on a URL and data entries based on a model representation according to the type indicator 312. As a result, the web browser may be aware of the difference between these two types of data entries within the history list. In an embodiment of the present invention, the redisplaying unit shown in FIG. 2 is further configured to display the page content stored at the history list only if the type indicator included in the stored data entry indicates that the stored data entry includes a model representation. Thus, a model representation included in the stored data entry, such as a subset of a DOM, is only restored when this condition is present. The redisplaying unit is further configured to retrieve a document identified by a stored URL included in a stored data entry only if the type indicator included in the stored data entry indicates that the data entry comprises a URL. The stored URL may be the URL 310 described above or may be a different data structure. Thus, behavior when this condition is present may be similar to web browsers known in the art.

The data entry 212 has a type indicator 312 which indicates that the stored data entry includes a model representation 214. Therefore, according to this embodiment, for the data entry 212, the redisplaying unit displays the page content included in the stored data entry 212. Specifically, the redisplaying unit may display page content included in the model representation 214.

By contrast, the data entry 302 has a type indicator 312 which indicates that the data entry comprises a URL. Therefore, according to this embodiment, for the data entry 302, the redisplaying unit retrieves a document identified by a stored URL included in the stored data entry 302. Specifically, the redisplaying unit may retrieve a document identified by the URL 310.

It will be appreciated that data entries indicated by a type indicator 312 as comprising a URL behave in a similar manner to the history functionality of web browsers known in the art. Therefore, the present invention may beneficially be implemented in a web browser while still maintaining backwards compatibility with the behavior of web browsers known in the art. Indeed, if an end user does not access web-based applications which store data entries comprising a model representation at the history list, all data entries stored at the history list 118 will be indicated by a type indicator as comprising a URL. It is thus evident that in this case, the behavior of the history list according to the present invention is similar to, or identical to, the behavior of the history functionality of web browsers known in the art.

The type indicator 312 additionally enables seamlessly interleaving data entries based on a URL and data entries based on a model representation within the same history list. Therefore, the history list may beneficially be ordered chronologically without regards to the type of each data entry. Moreover, data entries based on a model representation may be visually displayed in a manner consistent with data entries based on a URL. Thus, the type indicator 312 advantageously allows data entries including a model representation according to the present invention to be integrated with the history functionality of web browsers known in the art.

Turning now to FIG. 4, an API providing an interface to the present invention is shown.

The Application Programming Interface (API) 402 provides an interface to the present invention. Web-based applications may access this interface in order to invoke the functionality of the present invention. The API may be provided by a web browser such as the web browser shown in FIGS. 1 and 2.

It is noted that the present invention does not require that only a single API 402 is provided. To the contrary, a plurality of API's may be provided as an interface to the present invention. In FIG. 4, the API 402 shown is the only API provided.

The API 402 may be based on the JavaScript programming language and environment. This beneficially enables program code expressed in the JavaScript programming language to invoke the API. It is emphasized that the present invention does not require that the API is based on the JavaScript programming language. To the contrary, API's may be provided which are based on a wide variety of programming languages known in the art.

In an embodiment of the present invention, the API 402 is attached to an object within a DOM representing a current web page and provided by a web browser. The DOM may be the DOM shown in FIGS. 1 and 2. In a further embodiment of the present invention, the API is attached or associated with the “window” element included in the DOM. In many web browsers known in the art, the window element of the DOM has access to the current URL, a history, and other entities related to the user interface of the web browser. Therefore, it is advantageous from a taxonomy standpoint to associate the API with the window element.

The API may facilitate operations on a chronologically ordered history list such as the history list shown in FIG. 3. Furthermore, the API may facilitate manipulating data entries within the history list. The data entries may be similar to any of the data entries shown in FIG. 3.

The API 402 may provide a store function 404 configured to store a data entry in a chronologically ordered history list. The store function may perform any of the actions described above as performed by the storing unit of FIG. 2. The store function may receive as input a model representation which is hierarchical and object-oriented. The model representation may be a DOM or a subset thereof. The store function may additionally receive a name to be associated with the data entry. The store function may additionally receive as input a tag by which the stored data entry may be accessed. The store function may additionally receive as input a URL to be associated with the data entry.

The store function 404 causes a data entry to be stored at the history list. The data entry is stored at the current point in the history list. As noted above in regards to FIG. 3, the current point in the history list may be indicated by a pointer. The data entry includes the received model representation. If received as input, the data entry additionally includes the name, the tag and the URL. Therefore, if the received model representation is a DOM and a name is received as input, a DOM state is saved at the history list along with an associated name. Furthermore, if the received model representation comprises new page content received from a server, the new page content is stored in the data entry at the history list.

The store function 404 may be a method, with the inputs described above being passed as parameters to the method. In an embodiment of the present invention, the store function is named “saveHistoryItem”. Accordingly, the store function may be invoked via syntax such as “window.saveHistoryItem(<pageName>, <documentElem>)”. The pageName parameter may be stored as the name to be associated with the data entry. Thus, the value of the pageName parameter may be displayed when the history list is displayed visually. The pageName parameter may, instead or additionally, be stored as the tag by which the data entry may be accessed. The documentElem parameter contains the model representation. Specifically, the documentElem parameter may be an XML representation of the web page currently being viewed by the end user. The documentElem parameter may be a root element of the current state of the page. The root element may be the <body> HTML element. Passing the root element as a parameter may cause all elements included in a tree rooted at the root element to be passed or to otherwise be made available to the store function.

A web-based application may invoke the store function 404 directly within, or at the end of a handler function invoked within, the onLoad=attribute of the <body> HTML element of a complete web page. The invocation may comprise the syntax described above. Those skilled in the art will appreciate that program code included in the onLoad=attribute of the <body> HTML element is executed once the web page including the <body> HTML element has completed loading. As a result, once the web page is completely loaded, the current state of that web page is stored at the history list.

A web-based application may also invoke the store function 404 directly within, or at the end of a handler function invoked within, the onclick=attribute of an HTML element. The HTML element may instantiate a user interface element such as a button. As in the preceding case, the invocation may comprise the syntax described above. Those skilled in the art will appreciate that program code included in the onclick=attribute of an HTML element is executed when the user interface element instantiated by the HTML element is clicked by the end user. As a result, the state of the web page as of when the button is clicked, possibly including any changes resulting from clicking the button, is stored at the history list.

It is emphasized that the store function is not required to be invoked from the points described above. To the contrary, the store function may be invoked from any point in program code or a web page where such invocation is syntactically and semantically valid.

It is contemplated that by invoking the store function 404 as described above, the need to programmatically override the behavior of a Back button and/or a Forward button provided by the web browser is avoided. This is the case because page content saved using the store function is accessible via the default behavior of the Back button and the Forward button provided by the present invention.

The API 402 may further provide a restore function 406 configured to redisplay page content stored at the history list. The restore function may perform any of the actions described above as performed by the redisplaying unit of FIG. 2. In an embodiment of the present invention, the restore function 406 receives a tag. The restore function retrieves the data entry from the history list for which the tag included in the data entry has the same value as the tag received by the restore function. The tag may be the name associated with the data entry. The tag may also be a data field which is distinct from the name. Page content included in the retrieved data entry is redisplayed.

Accordingly, the restore function enables a web-based application to programmatically redisplay page content saved at the history list. The page content thus redisplayed need not be found in the immediately preceding data entry within the history list. To the contrary, specifying a tag as described above enables the application to arbitrarily select page content to be redisplayed. The restore function may affect both backward and forward traversal of the history list.

The restore function 406 may be a method, with the input described above being passed as a parameter to the method. In an embodiment of the present invention, the restore function is named “restoreHistoryItem”. Accordingly, the restore function may be invoked via syntax such as “window.restoreHistoryItem(<pageName>)”. Page content included in the data entry having a tag matching the pageName parameter is thus redisplayed.

It is noted that a web page invoking the restore function 406 may be overwritten by the restore function. However, the JavaScript engine may be separate from the DOM once the web page is loaded. Therefore, the restore function, and any program code included in the web page and invoking the restore function, may continue to execute even as the DOM is modified.

A web-based application may provide a customized Back button and/or a customized Forward button. If either button is pressed or otherwise activated by the user, the application may invoke the restore function 406 to restore the appropriate saved state.

The API 402 may further provide a clear function 408 configured to remove a stored data entry from the history list. In an embodiment of the present invention, the clear function 408 receives a tag. The clear function removes each data entry from the history list for which the tag included in the data entry has the same value as the tag received by the clear function. It is noted that a single invocation of the clear function may therefore remove a plurality of data entries from the history list.

The clear function 408 may be a method. In an embodiment of the present invention, the clear function is named “clearHistoryItems”. Accordingly, the clear function may be invoked via syntax such as “window.clearHistoryItems(Array<pageName>)”. The pageName parameter is an array including one or more elements, with each element being a tag. The clear function iterates over the array, performing the actions described above for each tag included in the array. Again, the tag may be the name associated with the data entry or may be a data field which is distinct from the name. If the method receives an array with zero elements, the method may exit without removing any data entries from the history list or may instead raise an exception condition.

A web-based application may invoke the clear function 408 to remove obsolete data from the history list. For example, every data entry in the history list which is associated with an online ordering process may include a tag of “purchase-flow”. When the online order is completed, the clear function is invoked. The “purchase-flow” tag is passed as a parameter to the clear function. As a result, all data entries associated with the online ordering process are removed from the history list. This beneficially prevents an accidental duplicate purchase of any items selected during the ordering process.

A web-based application may also invoke the clear function 408 to remove sensitive data from the history list. For example, an application with a sub-windowing environment may provide a Close button. An end user may press or otherwise activate the Close button to terminate the session. In response to activation of the Close button, the application may invoke the clear function to clear data from the history list in case, for example, the end user is located at a public terminal.

By utilizing an API such as the API 402 shown in FIG. 4, an application may provide improved user interface metaphors for backward and forward navigation. This is particularly true in the case of an application which manipulates a Document Object Model. Such applications may include applications based on the Web 2.0 paradigm as well as applications based on AJAX.

The developer of a web-based application may invoke the API 402 in order to specify “flow points.” Flow points are points at which the state should be saved. Flow points may include points at which an end user perceives a page change or a view change in terms of the traditional WWW user interface. A flow point may be saved by invoking the store function 404.

It is emphasized that the developer of a web-based application invoking the API 402 is ultimately responsible for determining and selecting optimal flow points. It is contemplated that neither the API nor the web browser is capable of determining the application flow. Therefore, the web browser requires input as to the identity of the flow points. This is the case because web-based applications vary dramatically in functionality and therefore will have different flow points. For example, a mapping application will probably have significantly different flow points compared to an electronic commerce application having a standard “add to cart, view cart, checkout, payment” application flow. By contrast, the web-based application is typically highly aware of the application flow.

Moreover, the developer of a web-based application is responsible for adding logic to detect that an end user failed to follow the expected page flow. Leaving the expected page flow may cause states saved at the history list to be invalid. For example, a saved state may depend on data stored at a web server which is automatically deleted after 30 minutes of inactivity. If a user leaves the expected page flow to visit another website (or simply takes a break from his or her terminal) and returns two hours later, the web-based application should preferably detect this condition and remove the invalid saved state from the history. More generally, it is contemplated that handling data is the responsibility of the developer of the web-based application.

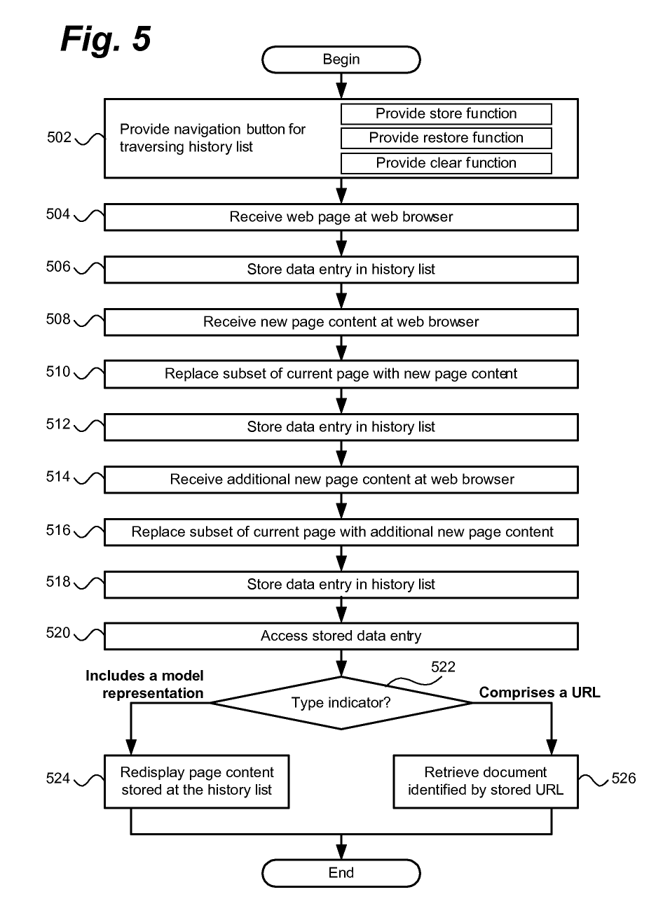

Turning now to FIG. 5, a flowchart of operations for managing a browsing history for a web browser is demonstrated.

At providing operation 502, at least one history navigation button for traversing a history list is provided. The history list is chronologically ordered. The history list thus traversed may be the history list shown in FIG. 3 and may have any or all of the properties described above regarding this history list. Moreover, the history list may store data entries such as the data entries shown in FIG. 3.

Providing operation 502 may include providing a Back button as defined above. The Back button may be labeled “Back” (or an equivalent thereof in a language other than English). Pressing or otherwise activating the Back button may cause content corresponding to the immediately preceding data entry in the history list to be redisplayed. The Back button may be inactive when no preceding data entry exists in the history list.

Providing operation 502 may further include providing a Forward button as defined above. The Forward button may be labeled “Forward” (or an equivalent thereof in a language other than English). Pressing or otherwise activating the Forward button may cause content corresponding to the immediately following data entry in the history list to be redisplayed. The Forward button may be inactive if no following data entry exists in the history list. It is noted that this case is quite common, as the most recent web content requested is frequently being displayed to an end user at any given moment in time.

It is emphasized that the user interface elements provided for navigating the history list are not limited to those described above. Notably, providing operation 502 may further include providing a drop-down menu listing options corresponding to some or all of the data entries included in the chronologically ordered history list. Selecting an option from the drop-down menu causes content corresponding to the selected option to be redisplayed. The drop-down menu may display names such as the names shown in the history list of FIG. 3.

Providing operation 502 may further comprise providing functions enabling computer code to access functionality provided by the present invention. Specifically, providing operation 502 may provide a store function configured to store a data entry comprising a model representation of new page content in a chronologically ordered history list. The store function may be the store function shown in FIG. 4. Providing operation 502 may also provide a restore function configured to redisplay page content stored at the history list. The restore function may be the restore function shown in FIG. 4. Providing operation 502 may also provide a clear function configured to remove the stored data entry from the history list. The clear function may be the clear function shown in FIG. 4. The functions described above may be provided as part of an Application Programming Interface (API) such as the API shown in FIG. 4.

After providing operation 502 is completed, control passes to receiving operation 504.

At receiving operation 504, a web page is received from a server at a web browser. Thus, this web page is the current web page. The web page is addressable by a Uniform Resource Locator (URL). This URL is noted as being associated with the current web page.

The web browser may be any of a wide variety of technological devices constituting a web browser as the term is defined above. The server may be any of a variety of technological devices configured to transmit web page content. In the flowchart of operations shown in FIG. 5, the web browser is the web browser 114 of FIGS. 1 and 2, and the server is the web server 104 of FIG. 1.

The web browser may display the received web page. Display of the received web page may occur within a window in a graphical user interface.

In an embodiment of the present invention, receiving operation 504 includes updating a Document Object Model (DOM) to include substantially all of the contents of the received web page. The DOM may be the DOM shown in FIGS. 1 and 2. Any update to the DOM, including the present update, is reflected in the currently displayed web page. Therefore, updating the DOM to include substantially all of the contents of the received web page causes the received web page to be displayed.

In the flowchart of operations shown in FIG. 5, the received web page includes a form by which an end user may specify a shipping address for an online order. Clicking a button within the form causes the shipping address to be transmitted via an AJAX request to a web server. The received web page comprises HTML and program code expressed in the JavaScript programming language.

After receiving operation 504 is completed, control passes to storing operation 506.

At storing operation 506, a data entry is stored in the history list. The data entry comprises a model representation of the web page received at receiving operation 504. Storing operation 506 may be invoked by the store function provided at providing operation 502. Broadly speaking, storing operation 506 may save a snapshot of the current state of the web page to the history list. Thus, storing operation 506 may store a data entry including a representation of the web page received at receiving operation 504 at the history list.

The data entry may be any of the data entries shown in FIG. 3. The data entry may have any of the properties of data entries described above in regards to FIG. 3.

The model representation is hierarchical and object-oriented. The model representation may be substantially equivalent to a subset of a Document Object Model (DOM). More specifically, the model representation may be substantially equivalent to a Display Subset of the DOM. The model representation may be the model representation shown in FIG. 3 and may have any of the properties described above regarding the model representation.

In an embodiment of the present invention, storing operation 506 includes storing the DOM representing the current web page as the model representation. As previously noted, the DOM comprises a representation of the web page received at receiving operation 504. In a further embodiment of the present invention, the DOM is stored in XML format.

Storing operation 506 may instantiate the history list if it does not already exist. However, if the history list exists, storing operation 506 will generally store the data entry at the existing history list instead of instantiating a second history list.

In an embodiment of the present invention, storing operation 506 comprises performing an in-memory copy of the current state of the DOM of the current web page in its entirety. The copy is then pushed onto a stack or stack-like data structure such as that described above regarding FIG. 3. As previously noted, for certain binary data, such as the contents of an image, the DOM may include addressing information, such as a URL, instead of the actual binary data. Any binary data not included in the DOM need not be copied. Those skilled in the art will appreciate that binary data such as images are frequently cached in a storage medium by the web browser. The URL included in the DOM may resolve to cached binary data or may be retrieved again via the Internet. Thus, copying the URL included in the DOM causes the binary content to be accessible based solely on the data included in the copy.

After storing operation 506 is completed, control passes to receiving operation 508.

At receiving operation 508, new page content from a server is received at the web browser. The server may be, but is not required to be, the same web server from which a web page was received at receiving operation 504.

In the flowchart of operations shown in FIG. 5, the new page content does not include a complete web page. Accordingly, the URL associated with the current web page is unchanged.

The received new page content may comprise markup language, such as HTML, which is intended to replace a subset of the page. For example, many web-based applications based on the Web 2.0 paradigm incorporate a concept known in the art as a “dashboard.” A dashboard includes multiple “tiles” on the same web page, with each tile being a self-contained content area. The server may transmit markup language containing updated content for a single tile.

The received new page content may instead comprise data which is intended to replace a subset of the page. For example, a web-based form may initially be populated with a drop-down list of countries. By default, the United States of America is the selected element within the list of countries. The form also has a drop-down list of political subdivisions. For consistency with the default country selection, the list of political subdivisions initially includes all 50 states in the United States and the District of Columbia. Suppose that the end user selects Japan from the list of countries. In response to this selection, an application executing at the web browser may transmit a request to the server. In response to the request, the server may transmit an array in JSON format which includes all of the prefectures of Japan.

In the flowchart of operations shown in FIG. 5, the end user specified a shipping address. An AJAX request including the specified address was transmitted to the server. Accordingly, the received new page content includes a drop-down menu including all the types of shipping (e.g., ground or air) which are available for shipping to the specified address.

After receiving operation 508 is completed, control passes to replacing operation 510.

At replacing operation 510, a subset of the current web page is replaced with the received new page content. Prior to replacing operation 510, the current web page is the web page received at receiving operation 504. Therefore, a subset of the web page received at receiving operation 504 is replaced with the new page content received at receiving operation 508.

The replaced subset does not include a complete web page. Therefore, the replaced subset is not required to be addressable by a URL.

In an embodiment of the present invention, replacing operation 510 includes updating the DOM to replace a subset of the contents thereof, namely a representation of the current web page, with the received new page content. As previously noted, this update to the DOM is reflected in the currently displayed web page. As a result, the subset of the currently displayed web page is replaced with the new page content.

In the example above wherein the server transmitted markup language containing updated content for a single tile, replacing operation 510 includes replacing the content included in the tile with the content indicated by the markup language thus transmitted.

In the example above wherein the server transmitted an array including all of the prefectures of Japan, replacing operation 510 includes replacing the options included in the list of political subdivisions with the elements of the array transmitted by the server.

The web browser, or program code executing thereat, may analyze or transform the received data before replacing the subset of the web page with the received data. For example, an application executing at a web browser may transmit a request to a server for updated stock prices. The server may respond with a list of updated stock prices. As the server has no knowledge of which stock prices are displayed on the current web page, only a subset of the stock prices included in the list are relevant. Therefore, the application may determine which stock prices are displayed on the current page and may update stock prices displayed on the current page with the corresponding data transmitted by the server.

In the flowchart of operations shown in FIG. 5, replacing operation 510 includes updating the DOM to include the transmitted drop-down menu listing the shipping types.

After replacing operation 510 is completed, control passes to storing operation 512.

At storing operation 512, a data entry is stored in the history list. The data entry comprises a model representation of the new page content received at receiving operation 508. Storing operation 512 may include any of the specific actions discussed above in regards to storing operation 506. Storing operation 512 may be invoked by the store function provided at providing operation 502. Storing operation 512 may save a snapshot of the current state of the web page to the history list. Thus, storing operation 512 may store a data entry including a representation of the new page content received at receiving operation 508 at the history list.

As previously noted, the data entry may be any of the data entries shown in FIG. 3. The data entry may have any of the properties of data entries described above in regards to FIG. 3.

Again, the model representation is hierarchical and object-oriented. The model representation may be substantially equivalent to a subset of a Document Object Model (DOM). More specifically, the model representation may be substantially equivalent to a Display Subset of the DOM. The model representation may be the model representation shown in FIG. 3 and may have any of the properties described above for the model representation.

It is emphasized that the model representation is not required to be strictly limited to the new page content received at receiving operation 508. Specifically, the model representation may additionally include content included in the current web page prior to replacing operation 510, such as the content received at receiving operation 504.

In an embodiment of the present invention, storing operation 512 includes storing the DOM representing the current web page as the model representation. As previously noted, the DOM comprises a representation of the new page content received at receiving operation 508.

After storing operation 512 is completed, control passes to receiving operation 514.

At receiving operation 514, additional new page content from a server is received at the web browser. Receiving operation 514 may include any of the specific actions discussed above in regards to receiving operation 508.

In the flowchart of operations shown in FIG. 5, the end user selected a shipping type. The shipping type is an air-based service which is guaranteed to arrive within 24 hours. Accordingly, the received new page content includes the cost for shipping according to the specified shipping type. The shipping cost is $75.00.

After receiving operation 514 is completed, control passes to replacing operation 516.

At replacing operation 516, a subset of the current web page is replaced with the received additional new page content. Replacing operation 516 may include any of the specific actions discussed above in regards to replacing operation 510. Prior to replacing operation 516, the current web page is the web page resulting from replacing operation 510. Therefore, a subset of the web page resulting from replacing operation 510 is replaced with the new page content received at receiving operation 514.

In the flowchart of operations shown in FIG. 5, replacing operation 516 comprises updating the DOM to include the shipping cost. Thus, the shipping cost is displayed to the end user.

After replacing operation 516 is completed, control passes to storing operation 518.

At storing operation 518, another data entry is stored in the history list. The data entry comprises a model representation of the additional new page content received at receiving operation 514. Storing operation 518 may include any of the specific actions discussed above in regards to storing operation 506 and storing operation 512. After storing operation 518 is completed, control passes to accessing operation 520.

At accessing operation 520, a data entry stored at the history list is accessed. Accessing operation 520 may be invoked by a user interface element, such as a Back button or Forward button, provided at providing operation 502. Accessing operation 520 may also be invoked by the restore function provided at providing operation 502.

Accessing operation 520 may first confirm that a history list has been instantiated. If the history list does not exist, accessing operation 520 may take no action. Accessing operation 520 may also take no action if the history list exists but contains zero data entries.

In the case where a Back button was pressed, accessing operation 520 may access the second most recently stored data entry in the history list. Thus, page content included in this data entry may subsequently be redisplayed as noted below. In the flowchart of operations shown in FIG. 5, the most recently stored data entry, namely the page content stored at storing operation 518, corresponds to the currently displayed web page. Thus, the second most recently stored data entry, which includes the page content stored at storing operation 512, is the saved state which immediately precedes the current state. Therefore, in this case, the second most recently stored data entry in the history list is accessed. As a result, the page content stored at storing operation 512 will be redisplayed.

Accessing operation 520 may instead access the most recently stored data entry in the history list. Thus, page content included in this data entry may subsequently be redisplayed as noted below. For example, further changes may have occurred to the displayed web content since the most recent storage of a data entry at the history list. In this case, the most recently stored data entry may correspond to a previously displayed web page. Therefore, the most recently stored data entry in the history list is accessed. As a result, the page content included in the accessed data entry will be redisplayed.

In an embodiment of the present invention, the data entry is accessed by performing one or more pop operations on a stack used to implement the history list. If the second most recent entry is to be redisplayed, two pop operations are performed. If the most recent data entry is to be redisplayed, only one pop operation is performed.

After accessing operation 520 is completed, control passes to determining operation 522.

As previously noted, each data entry may include a type indicator such as the type indicator shown in FIG. 3. At determining operation 522, a type indicator included in the stored data entry accessed at accessing operation 520 is read. If the type included in the stored data entry indicates that the stored data entry includes a model representation, control passes to redisplaying operation 524. As a result, displaying the page content in redisplaying operation 524 occurs only if the type indicator included in the stored data entry indicates that the stored data entry includes a model representation. If the type indicator included in the stored data entry indicates that the data entry comprises a URL, control passes to retrieving operation 526. It is contemplated that if the data entry does not include a type indicator, control passes to redisplaying operation 524.

At redisplaying operation 524, page content stored at the history list is redisplayed. The page content may be included in the stored data entry accessed at accessing operation 520.

In an embodiment of the present invention, redisplaying operation 524 comprises updating a Document Object Model (DOM) to include substantially all of the information in the model representation in the stored data entry. Specifically, the DOM shown in FIGS. 1 and 2 may be updated. Updating the DOM may comprise completely or partially replacing the DOM with the DOM or subset thereof included in the model representation. The web browser may then render the page based on the updated DOM. As a result, the content included in the updated DOM is displayed. Because the updated DOM includes the saved page content, the saved page content is redisplayed.

In the flowchart of operations shown in FIG. 5, the end user determines that the shipping cost is too expensive. The end user therefore clicks the Back button. The page content stored at the data entry stored at storing operation 512 is therefore redisplayed. As a result, the drop-down menu including all shipping types for the specified address is redisplayed. The end user may then select a shipping type having a lower cost.

After redisplaying operation 524 is completed, processing terminates.

At retrieving operation 526, a document identified by a stored URL included in the stored data entry is retrieved. The DOM may be updated to include substantially all of the information in the retrieved document. After retrieving operation 526 is completed, processing terminates.

It is emphasized that the present invention is not limited to the exact sequence of events shown in the flowchart of FIG. 5. To the contrary, receiving operation 504, which receives an entire web page, may be performed an arbitrary number of times. Receiving operation 508, which receives new page content not including an entire web page, may also be performed an arbitrary number of times. It is contemplated that each such repetition of receiving operation 508 is followed by replacing operation 510. Once an initial entire web page is loaded, receiving operation 504 may follow receiving operation 508 or vice versa. Storing operation 512 may be repeated an arbitrary number of times in order to store any page content which it may be advantageous to access at a later point in time. Accessing operation 520 and its subsequent operations may be invoked at any point in time.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

1. A method for managing a browsing history for a web browser, the web browser configured to display web page content, a web page being addressable by a Uniform Resource Identifier (URI), the method comprising:
receiving, at the web browser, new page content from a server;
replacing a subset of a current web page with the received new page content, wherein the replaced subset does not include a complete web page;
storing a data entry in a chronologically ordered history list, the data entry comprising a model representation of the new page content, the model representation being hierarchical and object-oriented;
providing at least one history navigation button for traversing the history list; and
redisplaying page content stored at the history list.

2. The method of claim 1, wherein redisplaying page content stored at the history list comprises updating a Document Object Model (DOM) to include substantially all of the information in the model representation in the stored data entry.

3. The method of claim 1, further comprising providing a restore function configured to redisplay page content stored at the history list.

4. The method of claim 1, further comprising providing a clear function configured to remove the stored data entry from the history list.

5. The method of claim 4, wherein:
each data entry in the history list comprises a tag;
the clear function receives the tag; and
the clear function removes each data entry from the history list for which the tag included in the data entry has the same value as the tag received by the clear function.

6. The method of claim 1, wherein the data entry further comprises a name of the page content.

7. The method of claim 1, wherein the data entry further comprises a Uniform Resource Locator (URL) of the page content.

8. The method of claim 1, further comprising:
wherein each data entry in the history list comprises a type indicator of the page content;
wherein redisplaying the page content includes displaying the page content only if the type indicator included in the stored data entry indicates that the stored data entry includes a model representation; and
retrieving a document identified by a stored URL included in a stored data entry only if the type indicator included in the stored data entry indicates that the data entry comprises a Uniform Resource Locator (URL).

9. A system for managing a browsing history for a web browser, the web browser configured to display web page content, a web page being addressable by a Uniform Resource Identifier (URI), the system comprising:
a processor;
a receiving unit, the receiving unit configured to receive, at the web browser, new page content from a server;
a replacing unit configured to replace a subset of a current web page with the received new page content, wherein the replaced subset does not include a complete web page;
a storing unit configured to store a data entry in a chronologically ordered history list, the data entry comprising a model representation of the new page content, the model representation being hierarchical and object-oriented;
a navigation unit configured to provide at least one history navigation button for traversing the history list; and
a redisplaying unit configured to redisplay page content stored at the history list.

10. The system of claim 9, wherein the model representation is substantially equivalent to a subset of a Document Object Model (DOM).

11. The system of claim 10, wherein the model representation is substantially equivalent to a Display Subset of the DOM.

12. The system of claim 9, wherein the data entry further comprises a name of the page content.

13. The system of claim 9, wherein the data entry further comprises a Uniform Resource Locator (URL) of the page content.

14. The system of claim 9, wherein:
each data entry in the history list comprises a type indicator of the page content;
the redisplaying unit is further configured to display the page content only if the type indicator included in the stored data entry indicates that the stored data entry includes a model representation; and
the redisplaying unit is further configured to retrieve a document identified by a stored URL included in a stored data entry only if the type indicator included in the stored data entry indicates that the data entry comprises a URL.

15. A computer program product embodied in computer readable memory comprising:
computer readable program codes coupled to the computer readable memory for managing a browsing history for a web browser, the computer readable program codes configured to cause the program to:
receive, at the web browser, new page content from a server;
replace a subset of a current web page with the received new page content, wherein the replaced subset does not include a complete web page;
store a data entry in a chronologically ordered history list, the data entry comprising a model representation of the new page content, the model representation being hierarchical and object-oriented;
provide at least one history navigation button for traversing the history list; and
redisplay page content stored at the history list.
